(19) United States
(12) Patent Application Publication
(10) Pub. No.: US 2014/0379573 A1
(43) Pub. Date: Dec. 25, 2014

(54) COMPUTER SYSTEM FOR CONTROLLING MACHINE BASED TRANSACTIONS

(71) Applicant: GLORY GLOBAL SOLUTIONS (INTERNATIONAL) LTMITED, Basingstoke, Hampshire (GB)

(72) Inventor: James William Long, Basingstoke (GB)

(73) Assignee: GLORY GLOBAL SOLUTIONS (INTERNATIONAL) LIMITED, Basingstoke, Hampshire (GB)

(21) Appl. No.: 14/370,535

(22) PCT Filed: Jan. 4, 2013
(86) PCT No.: PCT/EP2013/050094

§ 371 Date: Jul. 3, 2014

(30) Foreign Application Priority Data
Jan. 4, 2012 (GB) 1200080.8

(51) Int. Cl. G06Q 20/10; G05B 15/02

(52) U.S. Cl. CPC G06Q 20/1085; G05B 15/02
USPC 705/43

(57) ABSTRACT

According to one aspect the disclosure relates to a terminal for providing at least one machine based transaction facility for a customer. The terminal comprises: a user interface configured to receive input from a user for conducting transactions and to present to the user a request help option; a first communication interface operable to transmit a user request from the terminal when the request help option is selected to cause an alert to be activated at a separate device; and a second communications interface configured to detect a connection request from a controlling computer and to establish a communications link with the controlling computer by means of which the controlling computer can control operations of the terminal to assist the customer in effecting a transaction. According to another aspect the disclosure relates to a computer system for delivering transactions to a customer.

### TECHNICAL FIELD

This invention relates to a computer system for controlling machine based transactions, and particularly but not exclusively to automated machines in banks and other customer facings premises and means for controlling the operation of such machines.

### BACKGROUND

Automated banking machines are well-known. Two known examples of an automated banking machine which are commonly found in banks are a teller cash recycler (TCR) and a teller cash dispenser (TCD). A TCD can dispense notes only, under bank teller supervision, to a customer. A further type of known automated banking machine used by customers is an automated teller machine (“ATM”). ATMs are self-service machines which enable customers to carry out banking transactions without any assistance from a teller. Common banking transactions that may be carried out with ATMs include the dispensing of cash, the making of deposits, the transfer of funds between accounts, the payment of bills and account balance enquires. Other types of automated banking machines may allow customers to charge against accounts or to transfer funds. Other types of automated banking machines may print or dispense items of value such as coupons or vouchers. For the purposes of this disclosure an automated banking machine or automated transaction machine shall encompass any device which carries out customer based transactions including those which involve transfers of value.

It is usual for each banking machine located in bank branch to be connected to a central computer of the bank via a local teller network of the branch. This permits transactions performed by the machine to be linked with customer accounts. It also enables teller-operated machines to be monitored and controlled by bank staff located at a work station which is also connected to the teller network.

It is also common for an ATM to have a rear-mounted visual display that bank staff can use to determine information about the ATM itself. However, this display only shows information about the particular machine that it is attached to and cannot be used to see customer transaction flow or to aid a bank customer who is using the ATM.

FIG. 1A illustrates an example of a system architecture for a bank. A local network 14 has connected to it teller terminals 12 and banking machines 11 (of the type mentioned above). The local network 14 permits connection to the bank's central computer 16. As described above, the banking machines 11 can be provided on their rear side with a rear side 19 with a visual display (not visible in FIG. 1A) that bank staff (for example, a teller operator) can view. In addition, banking machines typically have a display 17 on their front side which is for facing a user of the banking machine (customer) and allowing them to complete their customer transaction.

### SUMMARY OF THE INVENTION

In one aspect the invention provides a terminal for providing at least one machine based transaction facility for a customer, the terminal comprising:
a user interface configured to receive input from a user for conducting transactions and to present to the user a request help option;
a first communication interface operable to transmit a user request from the terminal when the request help option is selected to cause an alert to be activated at a separate device; and
a second communications interface configured to detect a connection request from a controlling computer and to establish a communications link with the controlling computer by means of which the controlling computer can control operations of the terminal to assist the customer in effecting a transaction.

The described embodiments provide the ability to monitor a transaction flow by equipping the self-service terminal with a ‘request help’ feature. The ‘request help’ creates an alert at a remote monitoring point that alerts the bank staff to the need for them to provide assistance to the customer.

The second communications interface equips the self-service banking machine or a teller-operated machine (terminal) with a means for communicating with a remote device via a link which is separate from the teller network. The remote (separate) device can be the controlling computer. Alternatively, an alert can be raised at a separate device different from the controlling computer.

The invention also provides in another aspect, a computer system for delivering transactions to a customer, the system comprising:
at least one terminal comprising:
a user interface configured to receive input from a user for conducting transactions and to present to the user a request help option;
a first communication interface operable to transmit a user request from the terminal when the request help option is selected to cause an alert to be activated at a separate device; and
a second communications interface configured to detect a connection request from a controlling computer and to establish a communications link with the controlling computer by means of which the controlling computer can control operations of the terminal to assist the customer in effecting a transaction;
a network connected to the first communications interface for receiving the user request and conveying it to a controlling computer connected to the network.

The controlling computer can take the form of a remote and portable computer device (PC, iPad, Android Tablet) that is on the same network as the terminal self-service machine (ATM for example) or other banking machine (TCR or TCD for example). The link to the network can be hard-wired or wireless; (Wi-fi-Bluetooth, etc). Further, the remote computer is capable of monitoring multiple machines, not just with regards to their status, but also capable of monitoring the transaction flow and steps of multiple machines at the same time.

Further, the remote computer, via the direct communications link with a machine when it has been established is able to take control of a particular machine and complete the transaction at the machine or send help messages to the customer to allow them to resolve their problem and complete the transaction.

Further, the remote computer is optionally also able to lock the banking machine thereby blocking other user inputs during periods when the machine is under the control of the remote computer and so preventing accidental password disclosures.

Preferably, the remote computer is provided with a user interface; a touch screen incorporating a keypad, for example.

The remote computer may be used to control a TCR or TCD as an alternative to using the conventional teller workstation which is hardwired to the TCR or TCD or to using the TCR/TCD's on-board touch screen.

The remote computer may incorporate a browser for accessing the Internet for the purpose, for example, of down-loading the service manual of the banking machine that it is currently controlling. This facility also enables the remote computer to receive and send e-mail messages to a central location for fault reporting, for example.

The remote computer may be docked to a particular machine (by wired link) or can set up a wireless communication with it. Once communication with the machine is established, the remote computer's on-board display will show the information that would otherwise be shown on the banking-machine's own display unit or at the teller work station. Further, when the direct link with the banking machine has been established, the remote computer can be used to initiate a transaction or control a service and maintenance operation on the banking machine.

Preferably, the wireless link between the remote computer and the banking machine is encrypted for security reasons.

Optionally, the remote computer can respond to instructions from the user which are given verbally as an alternative to, or in addition to, the use of an associated keypad. The remote computer may also be capable of recognising the user, for example, by means of one camera or biometric sensor.

Another aspect of the invention provides a method of supporting a customer transaction at a terminal, the method comprising:
the terminal receiving selection of a request help option at a user interface of the terminal and transmitting via a first communications interface a user request to cause an alert at a separate device;
the terminal subsequently receiving a request for communication with a controlling computer via a second communications interface of the terminal, separate from the first communications interface, wherein a communications link is established between the controlling computer and the terminal responsive to that communication request; and
the terminal receiving control instructions via the communications link to control its operation.

The following described embodiments provide various advantages, including real-time monitoring of multiple customer transaction flows, transaction aid and customer support to an individual customer. The remote computer can replace some of the intelligence currently incorporated in banking machines. For example, it can communicate with the bank's branch computer or central computer via a wireless link. It can establish direct communication with a proximate banking machine, by sending out a polling signal for example, to which the machine responds. Then it can take charge of the transactions that the banking machine is required to carry out. It can be used for service and maintenance operations. Transaction and customer information are (securely) handled over the teller network while control and status monitoring of the machine is handled by the remote computer over a separate link. It may also be used to enable the queuing of operations, eg. to hold an instruction to empty a particular machine of its stored cash in a queue until a timer had expired and then initiate emptying the machine into an appropriate container.

For a better understanding of the invention and to show how the same may be carried into effect, reference will now be made by way of example, to the accompanying drawings.

### BRIEF DESCRIPTION OF THE DRAWINGS

FIG. 1 is a block diagram of the function components of a terminal;

FIG. 1A is a schematic diagram of a system architecture;

FIG. 2 show the layout of a user interface at a terminal;

FIG. 3 is a schematic diagram of an architecture in accordance with one embodiment of the invention;

FIG. 4 is a schematic block diagram of components of a terminal;

FIG. 5 is a schematic diagram illustrating message flow in a method according to an embodiment of the invention.

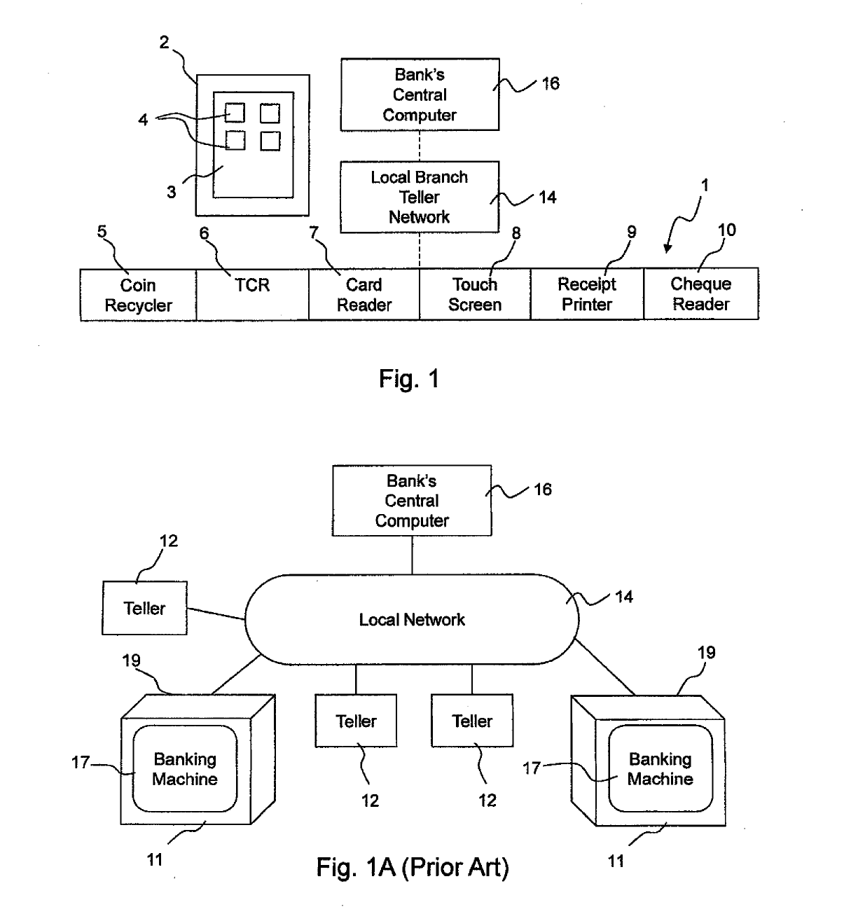

FIG. 1 is a block diagram of the functional components of a self service banking machine or terminal 1 and a remote computer 2 for controlling and communicating with such a machine 1. Hereinafter the remote computer 2 will be referred to as “tablet” 2.

The tablet 2 has a touch screen 3 with keys 4 and is operated by a bank's member of staff. Several of these tablets may be accessible in a bank branch for tellers to use simultaneously.

The banking machine 1 comprises a coin recycler 5, a banknote recycler 6, a customer card reader 7, a touchscreen display with keypad 8, a receipt printer 9 and a cheque reader 10. Several of these banking machines may be located within one bank branch.

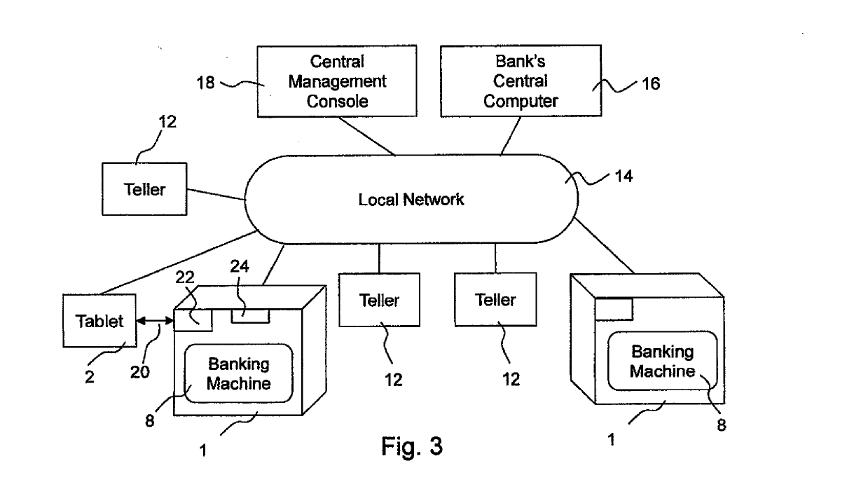

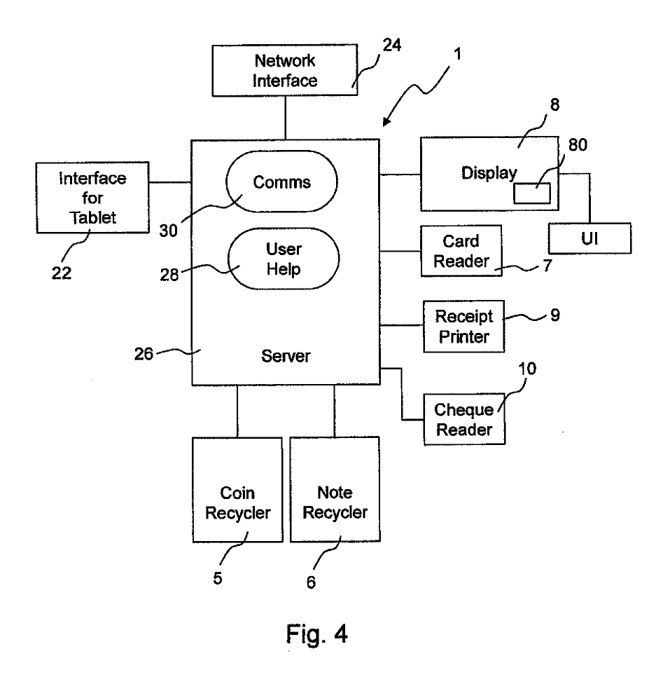

Each banking machine 1 can communicate with a local bank branch (teller) network 14 (FIG. 3) and with the tablet 2. The teller network 14 is connected to the bank's central computer 16. Each machine is provided with a server 26 (FIG. 4) for providing its status information and a control channel to the tablet 2 over a direct communication link. A more detailed description of the architecture and terminal is given later.

In operation, at startup, each banking machine 1 in a branch sends its status information via the local branch teller network 14 to a central management console 18. This information is conveniently sent over an Internet/intranet/web link. Each machine has the capability of discovering similar machines on the same network as itself, building up a list of such and communicating the list with any other machine which may be sending out a request for such information.

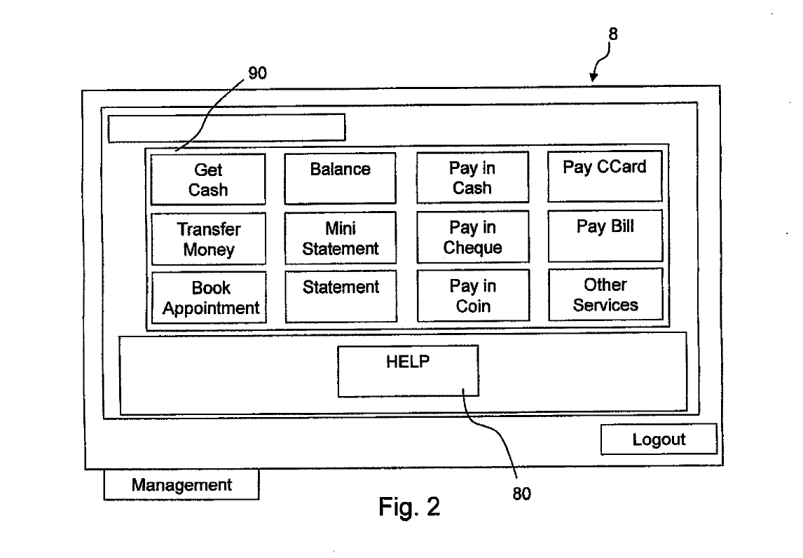

The machine's touch screen display 8 then presents information to a customer who wishes to carry out a transaction. An example of such information is shown in FIG. 2. The customer then follows the instructions which appear on this touch screen display 8 (as is conventional), depending on whether he wishes to deposit cash, deposit a cheque or withdraw cash, for example.

If the customer has difficulty in performing the transaction he touches the HELP key (80) on the touchscreen display 8. A help request is conveyed to the tablet 2 via the branch network and an alert is displayed on the tablet 2. In response, the bank teller, who is operating the tablet 2, walks over to the identified banking machine and sets up a direct communications link 20 (FIG. 3) with it. The displayed information of FIG. 2 now appears on the tablet's touchscreen 4. Hence, the operation and control of the machine 1 is handed off to the tablet 2. The teller can perform the attempted transaction for the customer using the tablet 2 and at the same time, demonstrate to the customer how to complete the transaction so that the customer will have the confidence to perform it himself next time. At the conclusion of the transaction, control of the banking machine 1 is handed off from the tablet to the banking machine's touch screen 8. The tablet 2 may then revert to monitoring the status of all the machines in the branch via the teller network.

The above arrangement will now be described in still more detail with reference to FIGS. 3 to 5. FIG. 3 illustrates the system architecture of a bank, where reference numeral 14 denotes the local teller network, and reference numeral 16 denotes the branch central computer, which can be similar to the network and computer described with reference to FIG. 1A. In addition, the local network 14 is connected to teller terminals 12, which can also be as described with reference to FIG. 1A. The banking machines 1 however, differ from the banking machines 11 discussed with reference to FIG. 1A in a number of respects. As mentioned above, each banking machine can communicate both with the local teller network 14 and with the tablet 2. To this end, they are equipped with a network communications interface 24 and a tablet communications interface 22. The tablet communications interface 22 allows the direct communications link (denoted by reference numeral 20) to be established with the tablet 2 to constitute the control channel by which the tablet 2 can control the banking machine. As with the banking machines 11 of FIG. 1A, they have a user facing display 8 on their front side, and can also be equipped with a visual display on their rear side 19.

The schematic architecture of such a banking machine 1 is shown in more detail in FIG. 4. The banking machine comprises a server 26 which can take the form of a processor with appropriate memory for executing code which can be stored in that memory or another memory to control operations of the banking machine. More generally, the server can take the form of any suitable computer architecture, being a single processor or multiple processors, capable of delivering functionality by hardware, software or firmware or any combination of the above. In the present case, two functional components will be described in particular, a user help component 28 and a communications component 30. These components can be implemented by suitable instruction sequences or code executed by the processor or processors of the server 26.

The banking machine also has code for providing conventional transaction facilities to a user. To the extent this code is known in the art, it will not be discussed further herein. It is configured to provide and execute the user selectable options as illustrated in FIG. 2, for example. However, it is to be noted that this code is modified in accordance with an embodiment of the present invention to display to the customer a help key 80 on the display 8. This is shown schematically in FIG. 4, and more clearly in FIG. 2. Transaction facilities of the banking machine are also displayed in FIG. 2 in the block of selectable functions marked 90. By way of example, these functions include:
Get cash
Transfer money
Book appointment
Request balance
Request mini statement
Request statement
Pay in cash
Pay in cheque
Pay in coin
Pay credit card
Pay bill
Other services

FIG. 4 shows the components of the banking machine which aid in providing customer transaction facilities as illustrated in FIG. 1, including the coin recycler, note recycler, etc. In addition, FIG. 4 illustrates the server 26 connected to the network interface 24 and to the tablet interface 22.

The network interface 24 provides a connection of the banking machine with the teller network 14 and thus with the banking central computer. This connection (via the network interface 24) allows transaction and customer information to be securely handled over the teller network with the bank's central computer 16. This attribute of a banking machine is known per se and so will not be discussed further herein.

The tablet interface 22 is an innovation presented herein and is supported by the communications component 30. When a request for connection is received from the tablet 2, the communications component 30 responds by setting up a communication link 20 between the tablet 2 and the tablet interface 22 to allow a control channel to be established from the tablet 2 to the banking machine 1. The manner in which the communications link 20 is established can vary depending on the system requirements or resources available. For example, it can be implemented by the tablet 2 physically connecting to a docking station which provides the tablet interface 22. In this case, the communications component senses that a tablet 2 is docked and operates the tablet interface 22 accordingly, to establish a connection. Alternatively, the connection could be established using Bluetooth or other short wave radio wireless technology. In that case, the tablet interface 22 could be a Bluetooth/RF or wireless interface controlled appropriately by the communications component 30. The operation of these different types of interfaces are known per se and will not be discussed further herein.

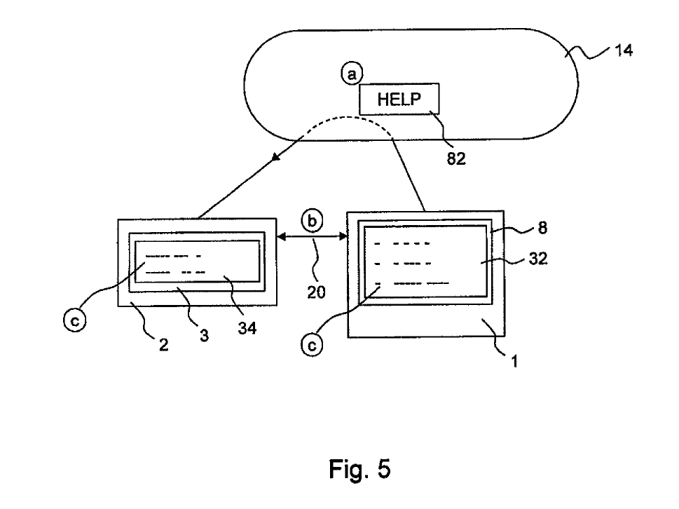

FIG. 5 shows in more detail the operation of the user help component 28 when the help key 80 is touched by a customer. Step (a) shows the help request 82 being conveyed to the tablet 2 via the local network 14, using the network interface 24 and its connection with the network 14. Note that when step (a) is being accomplished, there is no direct communication link between the tablet and the banking machine 1, that is steps (b) and (c) of FIG. 5 have not yet been accomplished.

As mentioned, earlier, the tablet has a touch screen which displays an alert responsive to the help request 82 when it is received via the bank network. The alert can be audio or visual and can take any form, for example a light, buzzer or text message or other visual element on the screen of the tablet. Alternatively, the alert can be generated on a teller terminal or the monitoring console. As further described above, the bank teller who is operating the tablet 2 approaches the banking machine 1 and requests a connection with the banking machine 1 to provide the communications link 20 shown in step (b). As will be clear from the description of FIG. 4, this is established by the communications component 30 whether by docking, Bluetooth, RF or any other way. Following this, in step (c), the screen appearing on the display 8 of the banking machine 1 then becomes available (screen 34) on the display of the tablet 2. This allows the operator of the tablet 2 to view what the customer is viewing and to aid in completing the transaction. The screen sharing and control is done via the control channel set up over the communications link 20.

It will be appreciated that whether the networks and connections described herein are wired or wireless is not important. In particular, the local network 14 could be a wireless LAN, for example, or a wide Ethernet network. What is important is that the banking machine 1 is capable of communicating via the local network 14 through its network interface, and separately with a tablet 2 through a direct link with its tablet interface 22. Furthermore, the tablet 2 is capable of communicating via the local network 14 and also via the communication link established with the banking machine 1. The network channel and the direct channel in each case are separate and in particular, one of these could be made secure, while the other one does not necessarily need to be secure. Alternatively, both channels can be made secure.

By allowing the tablet 2 to communicate via the local network 14 with the branch central computer 16, the tablet 2 can replace some of the intelligence currently incorporated in banking machines. Moreover, it can more readily update features of the banking machine by directly conveying information from the branch central computer 16.

1. A terminal for providing at least one machine based transaction facility for a customer, the terminal comprising:
a user interface configured to receive input from a user for conducting transactions and to present to the user a request help option;
a first communication interface operable to transmit a user request from the terminal when the request help option is selected to cause an alert to be activated at a separate device; and
a second communications interface configured to detect a connection request from a controlling computer and to establish a communications link with the controlling computer by means of which the controlling computer can control operations of the terminal to assist the customer in effecting a transaction.

2. A terminal according to claim 1, wherein the first communication interface is operable to supply transaction data for conducting transactions from the terminal to a central computer.

3. A terminal according to claim 1, wherein the terminal comprises a processor operable to receive instructions over the communications link established with the second communications interface and to supply transaction data via the tablet interface over the communications link.

4. A terminal according to claim 3, wherein the processor is configured to execute a user help component which is responsive to activation of the request help option to transmit that user request via the first communications interface.

5. A terminal according to claim 1, wherein the user interface comprises a display configured to display a help key to a user, wherein the actuation of the help key triggers transmission of the user request.

6. A terminal according to claim 4, wherein the processor is configured to render on the display information for a customer to utilise the transaction facility and to transmit screen sharing data via the tablet interface and the communications link to the controlling computer to share the display information on a display at the controlling computer.

7. A terminal according to claim 1, wherein the at least one transaction facility is selected from the dispensing of cash, the making of deposits, the transfer of funds between accounts, the payment of bills and account balance enquiries.

8. A terminal according to claim 1, wherein the processor is configured to receive a locking instruction via the second communication interface to lock the terminal against further user input while the machine is under the control of the controlling computer.

9. A terminal according to claim 1 which comprises a docking station incorporating the tablet interface for docking the controlling computer and establishing the communication link via that docking.

10. A terminal according to claim 1, wherein the second communication interface is a wireless interface.

11. A terminal according to claim 1, wherein the processor is configured to encrypt data prior to transmitting the data over the second communication interface and the communications link.

12. A computer system for delivering transactions to a customer, the system comprising:
at least one terminal comprising:
a user interface configured to receive input from a user for conducting transactions and to present to the user a request help option;
a first communication interface operable to transmit a user request from the terminal when the request help option is selected to cause an alert to be activated at a separate device; and
a second communications interface configured to detect a connection request from a controlling computer and to establish a communications link with the controlling computer by means of which the controlling computer can control operations of the terminal to assist the customer in effecting a transaction;
a network connected to the first communications interface for receiving the user request and conveying it to a controlling computer connected to the network.

13. A system according to claim 12, wherein the controlling computer is operable to generate an alert to an operator responsive to the user request.

14. A system according to claim 12, wherein the controlling computer is manually operable to transmit a communication request to the terminal to establish the communications link with the terminal.

15. A system according to claim 12, wherein the device is configured to monitor a plurality of terminals.

16. A system according to claim 15, wherein the separate device is the controlling computer which is operated to direct a communication request to a terminal from which a user request has been received.

17. A method of supporting a customer transaction at a terminal, the method comprising:
the terminal receiving selection of a request help option at a user interface of the terminal and transmitting via a first communications interface a user request to cause an alert at a separate device;
the terminal subsequently receiving a request for communication with a controlling computer via a second communications interface of the terminal, separate from the first communications interface, wherein a communications link is established between the controlling computer and the terminal responsive to that communication request; and
the terminal receiving control instructions via the communications link to control its operation.

18. A method according to claim 17, wherein the monitoring computer supplies a locking instruction to the terminal to prevent further user input while the terminal is under the control of the monitoring computer.

19. A method according to claim 17, comprising:
prior to the terminal receiving control instructions via the communication link, the terminal receiving user input from a user to conduct a transaction wherein the control instructions assist the customer in effecting the transaction.
